(19) United States
(12) Patent Application Publication
(10) Pub. No.: US 2026/0221409 A1
(43) Pub. Date: Jul. 30, 2026

(54) OPEN PATH PLANAR GEOMETRY LED TRIGGERED FLASH LAMPS

(71) Applicant: Excelitas Technologies Corp., Waltham, MA (US)

(72) Inventors: David Vidal, Amesbury, MA (US); William Eggleston, Billerica, MA (US); Daniel Meier, Norton, MA (US)

(21) Appl. No.: 19/456,906

(22) Filed: Jan. 22, 2026

Related U.S. Application Data
(60) Provisional application No. 63/749,428, filed on Jan. 24, 2025.

(51) Int. Cl. H01J 61/54; H01J 61/16

(52) U.S. Cl. CPC H01J 61/54; H01J 61/16

(57) ABSTRACT

The techniques described herein relate to flash lamps. An example flash lamp includes a housing comprising a sealed cavity comprising gas being capable of emitting first light, at least one window configured to emit the first light and receive second light from a light emitting diode, and an anode and a cathode coupled to the housing, respective portions of which are disposed in the cavity, and the anode and the cathode are separated by a distance in the cavity for electric arc generation across the distance in response to excitation of the gas by the second light.

### RELATED APPLICATION

This patent claims priority under 35 U.S.C. § 119(e) to U.S. Provisional Application No. 63/749,428, titled “OPEN PATH PLANAR GEOMETRY LED TRIGGERED FLASH LAMPS,” filed on Jan. 24, 2025, which is hereby incorporated by reference herein in its entirety.

### FIELD

The techniques described herein relate generally to flash lamps and, more particularly, to open path planar geometry LED triggered flash lamps.

### BACKGROUND

Flash lamps for producing high intensity broad spectrum light pulses may be used in different applications for analytical diagnostics such as spectroscopy, gas detection, and machine vision. Flash lamps of this type discharge energy from capacitors or some other energy storage device in an electric arc in an ionizable gas within a cathode to anode gap to produce light pulses useful for analytical instruments. This arc is initiated as a voltage breakdown between the cathode and a guide probe which is positioned between the cathode and the anode. This breakdown is triggered by a source of high energy photons within the cathode to probe region which lowers the work function of the cathode causing an arc streamer to form between the cathode and guide probe which then commutes to the anode discharging the stored energy across the anode to cathode gap.

### SUMMARY

In accordance with the disclosed subject matter, open path planar geometry LED triggered flash lamps are provided.

Some embodiments relate to a flash lamp comprising a housing comprising a sealed cavity comprising gas being capable of emitting first light, at least one window configured to emit the first light and receive second light from a light emitting diode, and an anode and a cathode coupled to the housing, respective portions of which are disposed in the cavity, and the anode and the cathode are separated by a distance in the cavity for electric arc generation across the distance in response to excitation of the gas by the second light.

Some embodiments relate to a method of manufacturing a flash lamp comprising disposing an end of an anode in a cavity of a housing by coupling the anode to the housing through a first opening, disposing an end of a cathode in the cavity by coupling the cathode to the housing through a second opening opposite the first opening, coupling a first window to a third opening in the housing, coupling a second window to a fourth opening in the housing, the second window configured to receive light from a light emitting diode, and sealing the cavity with gas capable of emitting second light through the first window.

The foregoing summary is not intended to be limiting. Moreover, various aspects of the present disclosure may be implemented alone or in combination with other aspects.

### BRIEF DESCRIPTION OF FIGURES

Various aspects and embodiments of the present technology will be described with reference to the following figures. In the figures, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques and devices described herein.

FIG. 1 is a perspective view of an example flash lamp, according to some embodiments.

FIG. 2 is an exploded view of a portion of the flash lamp of FIG. 1, according to some embodiments.

FIG. 3 is an exploded view of a portion of the flash lamp of FIG. 1 including the cathode assembly, according to some embodiments.

FIG. 4 is an exploded view of a portion of the flash lamp of FIG. 1 including the guide probe assembly, according to some embodiments.

FIG. 5 is an exploded view of a portion of the flash lamp of FIG. 1 including the LED window assembly, according to some embodiments.

FIG. 6 is an exploded view of a portion of the flash lamp of FIG. 1 including the rear reflector assembly, according to some embodiments.

FIG. 7 is an exploded view of a portion of the flash lamp of FIG. 1 including the output window assembly, according to some embodiments.

FIG. 8 is a flowchart representative of an example process that may be performed to manufacture an example flash lamp, according to some embodiments.

### DETAILED DESCRIPTION

The present disclosure generally provides techniques for manufacturing, assembling, and/or testing open path planar geometry light emitting diode (LED) triggered flash-lamps with a grounded envelope and self-locating assembly features.

Conventional flash lamps use a photon source to initiate an electric arc in an ionizable gas within a cathode to anode gap to produce light pulses useful for analytical measurements. Some such flash lamps implement the photon source as a high frequency discharge across the insulation of an open circuit co-axial resonator. This resonator, called a sparker, is generally in the form of a sub assembly incorporated within the flash lamp and connected electrically between the cathode and anode through a capacitive-inductive circuit.

It has been recognized, in accordance with certain embodiments of this disclosure, that supplying photons by a short wavelength LED installed as part of the lamp driver circuit external to the lamp itself and positioned before an LED input window on the lamp body has several advantages. First, removing this photon source from the lamp proper eliminates the cost of assembling and installing the sparker and, second, in accordance with certain embodiments, using the LED as a photon source provides a more cost effective photon source with improved flash to flash photon production stability with respect to photon energy level and timing.

It has been recognized that conventional flash-lamp designs also generally consist of a header assembly with long leads supporting a cathode, an anode, and a guide probe which, after attachment to the leads, require manual manipulation to align the electrode tips, and therefore the discharge arc with respect to some customer interface datum on the lamp. This aligned header assembly is then installed within an envelope assembly with an output window creating a hermetic chamber. In accordance with certain embodiments, the header and envelope have been replaced with a substantially cylindrical lamp body with formed features to provide repeatable location of the electrodes with respect to an easily accessible customer interface datum, the lamp body outer diameter, without manual alignment.

In accordance with certain embodiments, this lamp construction is based on a cylindrical lamp body with an outer wall separated from a coaxial inner chamber by a thermally and electrically conductive shell with a tubular appendage installed through this shell for evacuation and back-fill with xenon or other gas. The gas may be capable of emitting light, such as infrared light, ultraviolet light, or other broadband light. Broadband light can correspond to light that covers a wide range of wavelengths, such as ranges of 25 nanometers (nm), 50 nm, 100 nm, 200 nm, etc.

In accordance with certain embodiments, an anode, a cathode, a guide probe, and an LED input window are arranged within a common plane (e.g., a common geometric plane) radially around the central axis of the outer wall (e.g., the outer perimeter of the lamp body shell) within the inner chamber and with supporting structures or features for the anode, the cathode, the guide probe, and the LED window passing through the lamp body shell within the common plane.

In accordance with certain embodiments, an output window is attached to the output end of the body cylinder parallel to the electrode plane to hermetically seal the device while allowing the transmission of useful light from the arc to some analytical device. For example, the light may be infrared light, ultraviolet light, or other broadband light. The end of the cylinder opposite the output window can be optionally capped off to maintain a hermetic seal with or without a reflector behind the arc or with a second window for coupling to an auxiliary light source or for a second output for a reference channel or other use.

The second window (not shown but may optionally be included) may be configured for optimized and/or otherwise improved transparency for wavelength(s) and/or wavelength range(s) of interest. The second window may be constructed, fabricated, and/or manufactured using borosilicate glass, glass, sapphire, or other suitable materials that can be configured for transparency for wavelength(s) and/or wavelength range(s) of interest.

In accordance with certain embodiments, for optimum light output and flash to flash consistency, the discharge arc across the anode to cathode gap can be controlled to a high degree of positional accuracy with respect to the customer interface datum. It is also desirable to realize this control in a cost effective and reliably repeatable manner.

In accordance with certain embodiments, to achieve this the cylindrical lamp body contains features to constrain the position of the anode, the cathode, and the reflector either directly, as for the cathode and the reflector, or indirectly through the use of a fixture, as for the anode, with respect to the customer interface which is simply the outer diameter and the flat output end surface of the cylindrical lamp body. These features can include holes and other features placed about the cylindrical lamp body that can be machined or otherwise formed to a high degree of accuracy.

The techniques described herein may be implemented in any of numerous ways, as the techniques are not limited to any particular manner of implementation. Examples of details of implementation are provided herein solely for illustrative purposes. Furthermore, the techniques disclosed herein may be used individually or in any suitable combination, as aspects of the technology described herein are not limited to the use of any particular technique or combination of techniques.

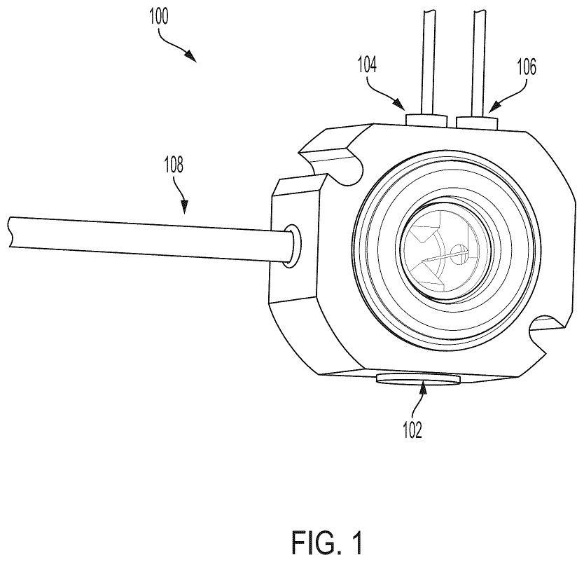

Turning to the figures, the illustrated example of FIG. 1 is a perspective view of an example flash lamp 100. The flash lamp 100 can be configured to excite a sealed gas using light emitted from a light emitting diode (LED) (not shown). Although the flash lamp 100 is discussed below in connection with at least one LED as an ignition source or igniter for the sealed gas, the techniques described herein are not limited in this respect, as other embodiments include (i) lamps constructed with at least one sparker and (ii) lamps constructed with a combination of at least one sparker and at least one LED, where (i) and (ii) can be configured use the self-aligning features associated with the anode, cathode, and/or other components discussed herein.

The flash lamp 100 of this example includes a cathode assembly 102, an anode assembly 104, a guide probe assembly 106, and a gas sealing assembly 108. The sealed gas can be excited to form an arc streamer to form between a cathode of the cathode assembly 102 and a guide probe of the guide probe assembly 106, which then commutes to an anode of the anode assembly 104 discharging the stored energy across the anode to cathode gap. The gas sealing assembly 108 can be used to evacuate and back-fill a cavity of the flash lamp 100 with gas. The gas may be xenon or other gas.

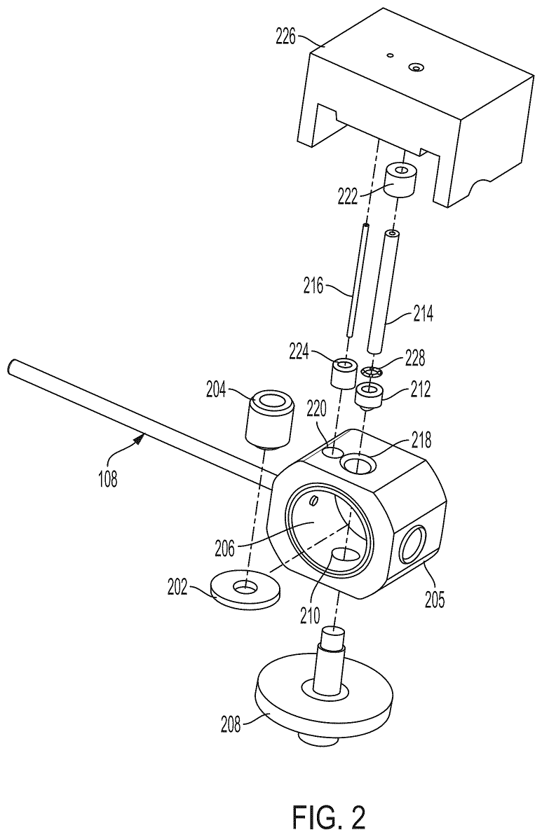

FIG. 2 is an exploded view of a portion of the flash lamp 100 of FIG. 1. Although example materials (e.g., borosilicate glass) are discussed for various parts, these are merely examples of different materials that may be used to form and/or construct the various parts and other materials are contemplated.

During construction of the flash lamp 100 shown in FIG. 2, a cylindrical guide probe support stop fixture 202 and a cylindrical anode centering sleeve fixture 204 are positioned within a lamp body 205, such as within the lamp body inner chamber shown as cavity 206. The lamp body 205 may be a casing, housing, shell, etc.

As shown, an anode positioning pilot post fixture 208 is inserted into the cathode hole 210 of the lamp body 205 and through the guide probe support stop fixture 202 and the anode centering sleeve fixture 204. The anode centering sleeve fixture 204 will hold the anode 212 in position with respect to the customer datum and the cathode hole 210 during a glass sealing operation in which an anode support 214 and a guide probe support 216 are also hermetically sealed into the anode support hole 218 and the guide probe support hole 220.

The anode support 214 may be a rod. Alternatively, the anode support 214 may be a tube. The guide probe support hole 220 may be a rod. Alternatively, the guide probe support hole 220 may be a tube.

The anode support hole 218 as shown is a recessed opening (e.g., a recessed hole).

The anode support hole 218 may be integral to the housing 205. Additionally and/or alternatively, the guide probe support hole 220 may be a recessed opening (e.g., a recessed hole). The guide probe support hole 220 may be integral to the housing 205. The anode 212 may be disposed in the cavity 206 such that an end of the anode 212 (e.g., the conical point of the anode 212) is exposed and/or disposed in the cavity 206. These supports 214, 216 are positioned within these holes 218, 220 by sealing glass preforms 222, 224 and a pin positioning fixture 226. The anode 212 is shown with a cylindrical body that tapers down to a conical point.

In some embodiments, the anode 212 is brazed to the end of the anode support 214 within the cavity 206 (e.g., the inner chamber) of the lamp body 205 during the glass sealing operation by placing a ring 228 of braze material of similar melting temperature to the glass sealing preform 222 in the junction of the anode 212 and the anode support 214. The brazing may be performed in a batch furnace operation. Together, the anode 212, the braze ring 228, the anode support 214, and the sealing glass preform 222 may form the anode assembly 104 of FIG. 1.

Example materials for various parts shown in FIG. 2 are provided below, but these are merely examples of different materials that may be used to form and/or construct the various parts and other materials are contemplated.

An example material to form and/or construct the guide probe support stop fixture 202 is stainless steel. An example material to form and/or construct the anode centering sleeve fixture 204 is graphite. An example material to form and/or construct the lamp body 205 is an iron nickel alloy. An example material to form and/or construct the anode positioning pilot post fixture 208 stainless steel. An example material to form and/or construct the anode 212 is tungsten. An example material to form and/or construct the anode support 214 is an iron nickel alloy. An example material to form and/or construct the guide probe support 216 is an iron nickel alloy. An example material to form and/or construct the sealing glass preform 222 is borosilicate glass. An example material to form and/or construct the sealing glass preform 224 is borosilicate glass. An example material to form and/or construct the pin positioner fixture 226 is graphite. Example materials to form and/or construct the braze ring 228 include gold, nickel, and copper alloy.

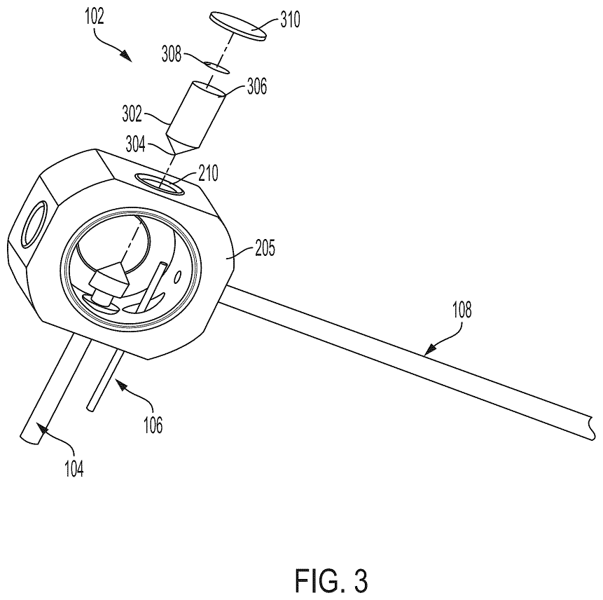

FIG. 3 is an exploded view of a portion of the flash lamp 100 of FIGS. 1 and/or 2 including the cathode assembly 102. After glass sealing, the fixtures 202, 204, 208, 226 of FIG. 2 are removed and a pre-made cathode assembly 102 including a cylindrical cathode 302, with a conical point 304 on one end and a flat surface 306 on the other end with the flat end brazed, using a braze disc 308, or otherwise attached to a cathode support disc 310, is inserted into the same hole 210 that the anode positioning fixture was removed from. The cathode support disc 310 can be welded or otherwise hermetically attached to the lamp body 205 at the rim of this hole 210. The hole 210 may be a recessed hole (e.g., a recessed opening). The hole 210 may be integral to the housing 205. The cathode 302 is shown with a cylindrical body that tapers down to the conical point 304.

The cathode 302 may be disposed in the cavity 206 such that the conical point 304 is exposed and/or disposed in the cavity 206. The cathode 302 and the anode 212 may be separated by a distance in the cavity 206 such that respective ends of the cathode 302 and the anode 212 may be separated by the distance for electric arc generation across the distance in response to excitation of the sealed gas by at least one LED. By controlling the length and the outer diameter of the cathode 302 and by controlling the diameter of the cathode hole 210 and its position, the cathode tip position will be maintained with respect to the anode tip and with respect to the customer interface datum. Together, the cathode 302, the braze disc 308, and the cathode support disc 310 may form the cathode assembly 102 of FIG. 1. Beneficially, the flash lamp 100 has the housing 205 connected electrically to a ground of the cathode 302 and to the system chassis for good charge dissipation.

Example materials for various parts shown in FIG. 3 are provided below, but these are merely examples of different materials that may be used to form and/or construct the various parts and other materials are contemplated.

An example material to form and/or construct the cathode 302 is tungsten. Example materials to form and/or construct the braze disc 308 include gold, nickel, and copper alloy. An example material to form and/or construct the cathode support disc 310 is an iron nickel alloy.

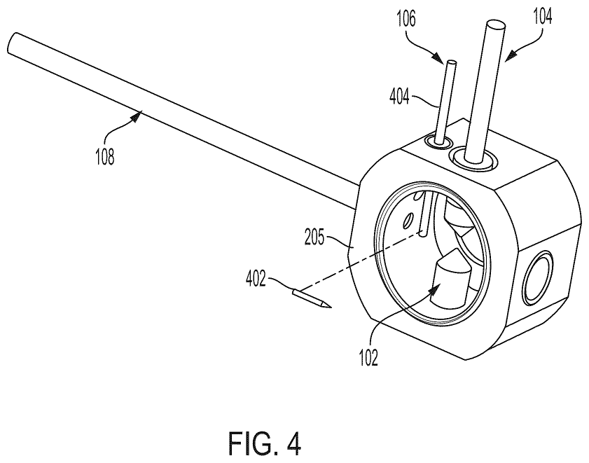

FIG. 4 is an exploded view of a portion of the flash lamp 100 of FIGS. 1, 2, and/or 3 including the guide probe assembly 106 of FIG. 1. As shown, a guide probe 402 including a thin pointed wire of some refractory metal or some other appropriate material is welded or otherwise attached to the internal end of the guide probe support 404 with the pointed tip robotically or otherwise positioned accurately with respect to the cathode tip of the cathode assembly 102. An example material for the guide probe 402 is tungsten.

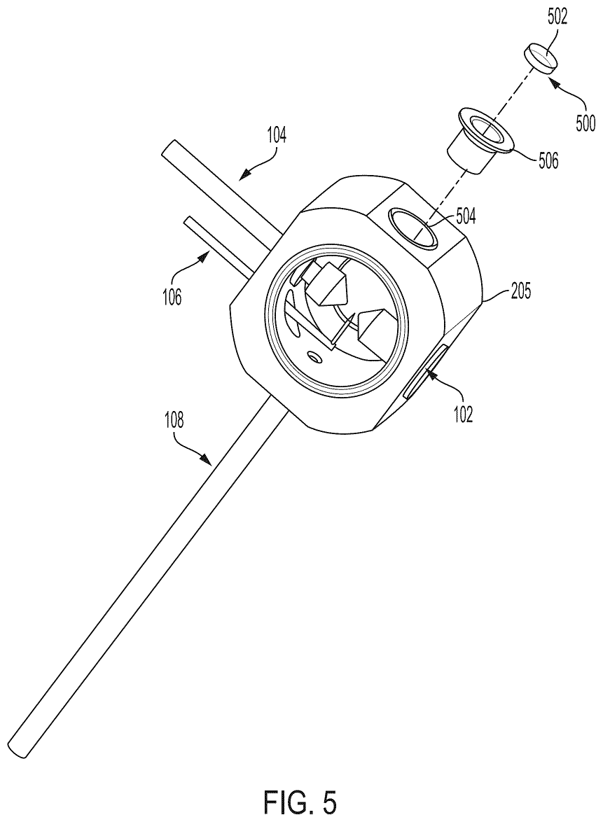

FIG. 5 is an exploded view of a portion of the flash lamp 100 of FIGS. 1, 2, 3, and/or 4 including an LED window assembly 500. As shown, an LED input window 502 including a selectively transmissive glass or other material is hermetically sealed into the LED window hole feature 504 in the lamp body 205. For example, the LED input window 502 may be configured for optimized and/or otherwise improved transparency for wavelength(s) and/or wavelength range(s) of interest. In some embodiments, the LED input window 502 is constructed, fabricated, and/or manufactured using borosilicate glass. Alternatively, the LED input window 502 may be made of glass, sapphire, or other suitable materials that can be configured for transparency for wavelength(s) and/or wavelength range(s) of interest.

The hole feature 504 may be implemented by a recessed opening (e.g., a recessed hole). The hole feature 504 may be integral to the housing 205. The LED input window 502 may be configured to receive light from one or more LEDs. In some embodiments, the LED input window 502 is coupled directly to the housing 205 with a glass frit seal. In some embodiments, the LED input window 502 is coupled to the housing 205 as part of an LED window and window support assembly 506 welded in place. The assembly 506 may include a flat ring having a first diameter and a cylindrical body having a second diameter smaller than the first diameter. An example material for the window support assembly 506 is an iron nickel alloy.

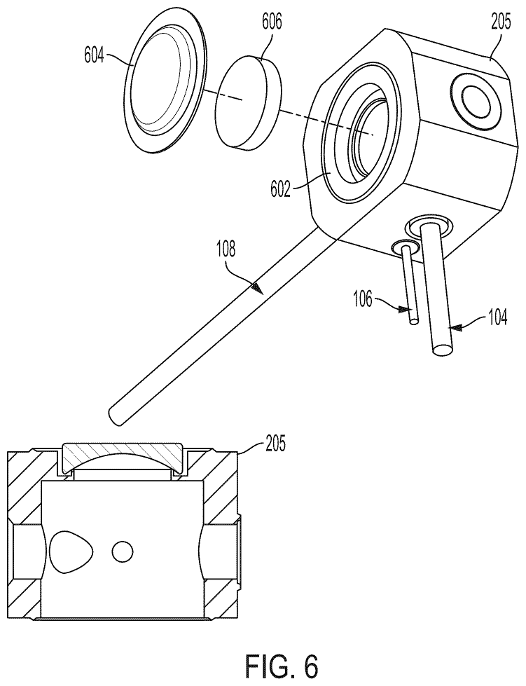

FIG. 6 shows an exploded view of a portion of the flash lamp 100 of FIG. 1 including the rear reflector assembly at the top right of FIG. 6, and a side view of the flash lamp 100 assembled at the bottom left of FIG. 6. As shown, the end of the lamp body cylinder (shown as opening 602, which may be a recessed opening that is integral to the housing 205) opposite the output end is sealed off by hermetically attaching a cap 604. In some embodiments, the cap 604 is attached with a reflector 606 behind the arc across the cathode and anode. The reflector 606 may be installed with the curved reflective surface nested against the lamp body datum feature as shown and a reflector retainer may be welded or otherwise hermetically attached to the lamp body 205 to hold the reflector 606 in place. The opening 602 is a lamp body datum feature for positioning the reflector 606.

In some embodiments, the cap 604 is attached without the reflector 606. In some embodiments, the cap 604 and the reflector 606 shown are not used, such as by attaching a second output window assembly (not shown) for coupling to an auxiliary light source, for use as a reference channel, or other use.

An example material for the cap 604 is an iron nickel alloy. An example material for the reflector 606 is an aluminum coated pyrex.

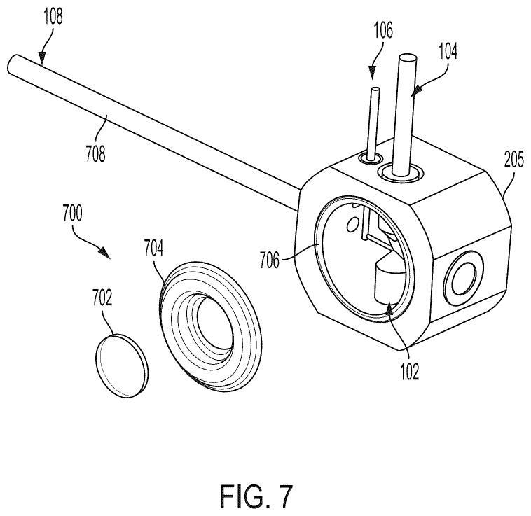

FIG. 7 is an exploded view of a portion of the flash lamp 100 of FIGS. 1, 2, 3, 4, 5, and/or 6 including an output window assembly 700. As shown, an output window 702 including a selectively transmissive glass or other material is then hermetically attached to the output end of the lamp body cylinder 205. For example, the output window 702 may be configured for optimized and/or otherwise improved transparency for wavelength(s) and/or wavelength range(s) of interest.

In some embodiments, the output window 702 is constructed, fabricated, and/or manufactured using borosilicate glass. Alternatively, the output window 702 may be made of glass, sapphire, or other suitable materials that can be configured for transparency for wavelength(s) and/or wavelength range(s) of interest.

In some embodiments, the output window 702 is coupled to the lamp body cylinder 205 directly with a glass frit. In some embodiments, such as the one shown, the output window 702 is coupled to the lamp body cylinder 205 as part of a window and window/seal-ring support assembly welded in place. Along with the window 702, the assembly may include a window seal ring 704 configured to be coupled to a groove (e.g., a raised groove) of opening 706 of the lamp body cylinder 205. The opening 706 may be a recessed opening. The recessed opening may be integral to the housing 205. An example material for the window seal ring 704 is an iron nickel alloy.

In some embodiments, the flash lamp 100 is evacuated and back-filled with gas using the gas sealing assembly 108. The gas may be xenon or other gas. The gas may be a gas mix. The gas or gas mix may be evacuated and back-filled to the appropriate pressure for the desired light output through the tubular appendage 708 of the gas sealing assembly 108 with lamp and vacuum device processing methods. The appendage 708 can be pinched closed or sealed off by some other method maintaining the proper gas atmosphere within the sealed lamp 100.

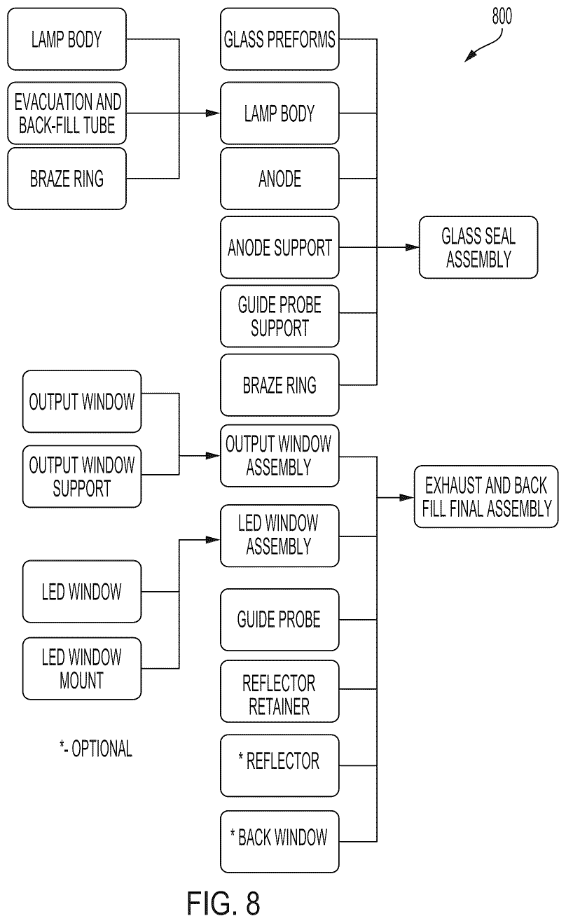

FIG. 8 is a flowchart 800 representative of an example process that may be performed to manufacture an example flash lamp. For example, the flowchart 800 may represent a method of manufacturing and/or testing a flash lamp assembled, constructed, and/or manufactured in accordance with the embodiments of this disclosure.

The process of the flowchart 800 can be performed to assemble, construct, and/or manufacture a glass seal assembly. As shown, a lamp body is assembled using a lamp body, an evacuation and back-fill tube, and a braze ring as disclosed herein. Glass preforms, the aforementioned lamp body, an anode, an anode support, a guide probe support, and a braze ring as disclosed herein are assembled into the glass seal assembly as disclosed herein.

The process of the flowchart 800 can be performed to assemble, construct, and/or manufacture the final assembly of a flash lamp, such as the flash lamp 100. As shown, an output window assembly is assembled using an output window and an output window support as disclosed herein. As shown, an LED window assembly is assembled using an LED window and an LED window mount as disclosed herein. The aforementioned output window assembly and LED window assembly, a guide probe, a reflector retainer, optionally a reflector, and optionally a back window are assembled into an assembly, which is exhausted and back-filled to complete and/or output the flash lamp (e.g., the flash lamp 100) as the final assembly.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Further benefits of the embodiments of this disclosure will now be described.

Flash lamps for producing high intensity broad spectrum light pulses may be used in different applications. Conventional flash lamps of this type discharge energy from capacitors or some other energy storage device in an electric arc in an ionizable gas within a cathode to anode gap to produce light pulses useful for analytical instruments. In flash lamps of this type, the position of the anode, the cathode, and the guide probe must be controlled with respect to each other and to the customer interface datum in a repeatable and cost effective manner. Conventional flash lamp designs generally involve attaching the electrodes to supporting structures that must be manipulated with hand tools to align them. Beneficially, flash lamps designed in accordance with the embodiments of this disclosure use a substantially cylindrical body with easily accessed customer datum and electrode locating features for placement and attachment of the electrodes.

In conventional flash lamps of this type, a photon source is required for triggering. The reliability of this source with respect to flash to flash intensity and timing is critical for stable flash to flash operation of the lamp. Conventional flash lamp designs generally use a coaxial resonator sparker as this photon source. These sparkers require costly assembly and installation and are inherently variable in construction and operation. Beneficially, flash lamps designed in accordance with the embodiments of this disclosure use a short wavelength LED as part of the driver circuit, eliminating the photon source entirely from the lamp proper. These LEDs are also less expensive and more consistent in operation than the coaxial sparker.

In conventional flash lamps of this type, it is important to dissipate the heat produced by the arc in order to avoid overheating of the electrodes which will shorten lamp life. Conventional flash lamp designs generally consist of an electrode arrangement within an envelope which can be either a thermally and electrically insulating material such as glass or a metallic envelope that is thermally and electrically insulated from the electrodes by some intervening material. In both of these configurations, the thermal management is fairly poor requiring large electrodes to limit wear. Beneficially, flash lamps designed in accordance with the embodiments of this disclosure have a fairly massive envelope that is electrically and thermally connected to the cathode with a very short anode support lead. This arrangement efficiently removes heat from the lamp operation.

In some conventional flash lamp designs, there can be a charge build-up on the glass envelope or on the metal envelope if insulated from the electrodes. This can cause misfiring of the lamp upon recharging of the driver circuit if the gas fill is not completely de-ionized between pulses. Also having the envelope insulated from the arc can cause charges to build up on the external surface which can cause arcing from the envelope to the system mounting features. Beneficially, flash lamps designed in accordance with the embodiments of this disclosure have the envelope connected electrically to the cathode ground (e.g., an electrical ground of the cathode) and to the system chassis for good charge dissipation.

Some conventional flash lamps are used in conjunction with auxiliary light sources to enhance the spectral characteristics of the light signal. This generally requires some form of optics for the combining of the separate light sources. Beneficially, flash lamps designed in accordance with the embodiments of this disclosure have an open path radial geometry that allows a second light source to be added directly to the output of the output from this lamp from behind the arc.

In some applications for conventional lamps of this type, it is desirable to know accurately what the spectral output of the lamp is prior to transmission through the sample material to be analyzed. This requires either some splitting optics to send part of the light output directly to a detector while also sending the split light through the sample, or alternately a baseline light output measurement is obtained prior to testing the sample. Beneficially, flash lamps designed in accordance with the embodiments of this disclosure have an accommodation for a second window on the backside of the arc where a detector can measure the output of the same arc which is used to analyze the sample. Additionally this second window can also be used for a second output for increased sample throughput for high volume testing.

In some conventional lamps of this type, a reflector is employed behind the arc in order to increase light output for a given operation wattage. In most conventional implementations, the reflector is positioned between the power leads for the electrodes within the lamp envelope. Generally, the limited space between the electrode leads and the requirement for electrical clearances constrains the size of the reflector. Beneficially, flash lamps designed in accordance with the embodiments of this disclosure have a radial arrangement of the electrodes and the power leads that allows for a large free area behind the arc for reflector placement, such that larger reflectors may be utilized than those that may be used in other lamps of this type.

In some conventional lamps of this type that employ any reflector or other optics it is important that the optic be aligned with both the arc and the application interface. Current reflector lamps generally mount a reflector from the back, non-optical, surface on some supporting structure which is then manipulated to position as a separate operation.

Beneficially, flash lamps designed in accordance with the embodiments of this disclosure use a locating feature on the same body cylinder that is controlling the electrode positions. This feature nests with the actual reflecting surface of the reflector assuring optimal alignment of the reflector to both the arc and the application interface.

The phrase “and/or,” as used herein in the specification and in the claims, should be understood to mean “either or both,” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

The indefinite articles “a” and “an,” as used herein in the specification and in the claims, unless clearly indicated to the contrary, should be understood to mean “at least one.” As used herein in the specification and in the claims, the phrase, “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently, “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A,, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

All definitions, as defined and used herein, should be understood to control over dictionary definitions, definitions in documents incorporated by reference, and/or ordinary meanings of the defined terms.

Having thus described several aspects of at least one embodiment, it is to be appreciated that various alterations, modifications, and improvements will readily occur to those skilled in the art. Such alterations, modifications, and improvements are intended to be part of this disclosure and are intended to be within the spirit and scope of the principles described herein. Accordingly, the foregoing description and drawings are by way of example only.

1. A flash lamp comprising:
a housing comprising:
a sealed cavity comprising gas being capable of emitting first light; and
at least one window configured to emit the first light and receive
second light from a light emitting diode; and
an anode and a cathode coupled to the housing, respective portions of which are disposed in the sealed cavity, and the anode and the cathode are separated by a distance in the sealed cavity for electric arc generation across the distance in response to excitation of the gas by the second light.

2. The flash lamp of claim 1, wherein the housing is a cylindrical housing.

3. The flash lamp of claim 1, wherein the gas is xenon gas.

4. The flash lamp of claim 1, wherein the first light is ultraviolet light, infrared light, or other broadband light.

5. The flash lamp of claim 1, wherein the housing comprises an opening, and further comprising a tube coupled to the housing through the opening, and the tube is configured to provide the gas to the sealed cavity.

6. The flash lamp of claim 1, wherein the at least one window comprises a first window configured to emit the first light and a second window configured to receive the second light.

7. The flash lamp of claim 6, further comprising a window mount comprising a flat ring having a first diameter and a cylindrical body having a second diameter smaller than the first diameter, the window mount coupled to the housing, and the second window is coupled to the flat ring.

8. The flash lamp of claim 6, wherein at least one of the first window or the second window comprises borosilicate glass, glass, or sapphire.

9. The flash lamp of claim 6, further comprising a reflector comprising a curved surface opposite the first window.

10. The flash lamp of claim 6, wherein the housing comprises a third window opposite the first window, and the third window is configured to at least one of receive third light from an auxiliary light source or emit the first light.

11. The flash lamp of claim 6, wherein the housing comprises a first opening configured with a groove, and further comprising a seal ring coupled to the groove, the seal ring comprising a second opening, and the first window is coupled to the seal ring through the second opening.

12. The flash lamp of claim 1, wherein the housing comprises an opening, and further comprising:
a guide probe support coupled to the housing through the opening, a portion of the guide probe support disposed in the sealed cavity; and
a guide probe inserted into the guide probe support such that a portion of the guide probe is exposed in the sealed cavity.

13. The flash lamp of claim 1, wherein the housing comprises a first opening and a second opening, the anode is coupled to the housing through the first opening, and the cathode is coupled to the housing through the second opening.

14. The flash lamp of claim 13, wherein at least one of the first opening or the second opening is a recessed opening.

15. The flash lamp of claim 13, wherein the first opening and the second opening are on opposite sides of the housing.

16. The flash lamp of claim 13, wherein the first opening and the second opening are integral to the housing.

17. The flash lamp of claim 1, wherein at least one of the anode or the cathode comprises a cylindrical body tapered to a conical point, the conical point of the at least one of the anode or the cathode disposed in the sealed cavity.

18. The flash lamp of claim 1, further comprising a braze ring, a rod, and sealing glass, a first end of the anode disposed in the sealed cavity, and a second end of the anode, opposite the first end, is coupled to the rod through the braze ring, and the sealing glass is coupled to the housing to hermetically seal the anode in the sealed cavity.

19. The flash lamp of claim 1, further comprising a braze disc and a support disc, a first end of the cathode disposed in the sealed cavity, a second end of the cathode, opposite the first end, is coupled to the support disc through the braze disc, and the support disc is coupled to the housing to hermetically seal the cathode in the sealed cavity.

20. The flash lamp of claim 1, wherein the at least one window is electrically coupled to the housing and a ground of the cathode.

21. A method of manufacturing a flash lamp comprising:
disposing an end of an anode in a cavity of a housing by coupling the anode to the housing through a first opening;
disposing an end of a cathode in the cavity by coupling the cathode to the housing through a second opening opposite the first opening;
coupling a first window to a third opening in the housing;
coupling a second window to a fourth opening in the housing, the second window configured to receive first light from a light emitting diode; and
sealing the cavity with gas capable of emitting second light through the first window.

22. The method of claim 21, wherein the end of the anode is a first end of the anode, and coupling the anode to the housing comprises:
coupling a fixture to the second opening by inserting an end of the fixture into the cavity through the second opening, the fixture configured to receivably couple the first end of the anode;
coupling the first end of the anode to the end of the fixture by inserting the first end of the anode into the cavity through the first opening;
coupling a braze ring to a second end of the anode, opposite the first end;
coupling a rod to the anode through the braze ring;
coupling a sealing glass preform to the rod; and
heating at least the braze ring and the sealing glass preform to couple the anode to the housing.

23. The method of claim 21, wherein the end of the cathode is a first end, and coupling the cathode to the housing comprises:
inserting the first end of the cathode into the cavity through the second opening;
coupling a braze disc to a second end of the cathode, opposite the first end;
coupling a support ring to the braze disc; and
heating at least the braze disc to couple the cathode to the housing.

24. The method of claim 21, further comprising testing the flash lamp by turning on the light emitting diode to emit the first light to cause excitation of the gas to emit the second light.
